(19) United States
(12) Patent Application Publication
(10) Pub. No.: US 2024/0235144 A1
(43) Pub. Date: Jul. 11, 2024

(54) Dustproof structure for laser output window of laser, and laser

(71) Applicant: BEIJING RSLASER OPTO-ELECTRONICS TECHNOLOGY CO., LTD., Beijing (CN)

(72) Inventors: Jinsong WU, Beijing (CN); Bin LIU, Beijing (CN); Xiangyu XU, Beijing (CN); Guangyi LIU, Beijing (CN); Rui JIANG, Beijing (CN); Wenbin CHEN, Beijing (CN)

(73) Assignee: BEIJING RSLASER OPTO-ELECTRONICS TECHNOLOGY CO., LTD., Beijing (CN)

(21) Appl. No.: 18/603,253

(22) Filed: Mar. 13, 2024

Related U.S. Application Data
(63) Continuation-in-part of application No. PCT/CN2022/081999, filed on Mar. 21, 2022.

(30) Foreign Application Priority Data
Sep. 14, 2021 (CN) 202111075642.4

(51) Int. Cl. H01S 3/034; H01S 3/036

(52) U.S. Cl. CPC H01S 3/0346; H01S 3/036

(57) ABSTRACT

A dustproof structure for a laser output window of a laser includes a discharge chamber, a gas purifier, a dust prevention pipeline, and a fan. A cavity is provided between the laser output window and a slit. The dust prevention pipeline includes a gas inlet end connected to the gas purifier, a middle part passing through the cavity, and a gas outlet end connected to the fan. At least a portion of a working gas purified by the gas purifier flows through the dust prevention pipeline to the cavity. The fan guides the working gas so as to increase a flow rate of the gas passing through the cavity, thereby strengthening the blowing of the clean gas on the laser output window and effectively preventing dust particles in the working gas from approaching and contaminating the laser output window.

### CROSS REFERENCE TO THE RELATED APPLICATIONS

This application is the continuation-in-part application of International Application No. PCT/CN2022/081999, filed on Mar. 21, 2022, which is based upon and claims priority to Chinese patent application Ser. No. 20/211,1075642.4, filed on Sep. 14, 2021, the entire contents of which are incorporated herein by reference.

### TECHNICAL FIELD

The present disclosure relates to the technical field of lasers, and in particular to a dustproof structure for a laser output window of a laser, and a laser.

### BACKGROUND

The discharge process of the discharge chamber of an excimer laser is accompanied by electrode erosion, resulting in the continuous generation of dust. The dust circulates with airflow to various positions inside the chamber, causing serious damage to the laser output window of the laser and the bearings of the cross-flow fan. Therefore, specialized protective devices are needed to maintain the normal operation of the laser output window and the bearings, and to extend their service life.

Specifically, as shown in FIG. 1, a working gas 1 in a discharge chamber 10 of a laser enters a gas purifier 20 (i.e. a metal fluoride trap (MFT)) through a gas outlet inside an upper chamber of the laser to remove dust through filtration. Then, the working gas 1 flows through a gas inlet and an intake channel inside the upper chamber and returns to the discharge chamber 10 through a light inlet of a slit 60 to continue working. The working gas 1 circulates in this way. In the figure, the arrow denotes the flow direction of the working gas 1. The intake channel inside the upper chamber of the laser is an exhaust channel of the MFT.

The laser output window 50 of the laser is provided outside the slit 60. The laser output window 50 and the slit 60 are adjacent and spaced a certain distance apart to form a gap. The slit 60 is provided with a light inlet opening. The gas purified by the MFT flows only through a small pressure difference to the gap between the laser output window 50 and the slit 60 and returns to the discharge chamber 10 through the slit. The gas flows at a small speed and is prone to blockage.

Due to the light inlet opening of the slit 60, the laser output window 50 cannot be completely isolated from the internal space of the discharge chamber 10. Therefore, dust inside the discharge chamber 10 is easy to enter the space between the laser output window 50 and the slit 60 through the light inlet opening of the slit 60, thereby contaminating the inner surface of the laser output window 50.

### SUMMARY

An objective of the present disclosure is to provide a dustproof structure for a laser output window of a laser, in order to solve at least one of the aforementioned technical problems existing in the prior art.

In order to solve the above technical problem(s), the present disclosure provides a dustproof structure for a laser output window of a laser, including a discharge chamber, a gas purifier, a dust prevention pipeline, and a fan, where

the gas purifier is configured to purify a working gas inside the discharge chamber;

the discharge chamber is provided with a laser output window and a slit;

a cavity is provided between the laser output window and the slit; and

the dust prevention pipeline includes a gas inlet end connected to the gas purifier, a middle part passing through the cavity, and a gas outlet end connected to the fan; at least a portion of the working gas purified by the gas purifier flows through the dust prevention pipeline to the cavity and forms a dustproof gas curtain on an inner side of the laser output window, so as to prevent the working gas, which comes from the chamber and enters the cavity through a window of the slit, from approaching and contaminating the laser output window; and the fan is configured to guide the working gas so as to increase a flow rate of clean gas passing through the cavity, thereby strengthening the blowing of the clean gas on the laser output window and effectively preventing dust particles in the working gas, which comes from the chamber and enters the cavity through the window of the slit, from approaching and contaminating the laser output window.

Further, a gas pressure inside the cavity is less than or equal to a pressure inside the discharge chamber.

Further, the working gas in the dust prevention pipeline flows back directly or through a pipeline to the chamber after passing through the fan.

The fan rotates and forms a certain negative pressure adjacent to the gas outlet end of the dust prevention pipeline, thereby forming a suction force that promotes the flow and outflow of the working gas in the dust prevention pipeline. Finally, the working gas enters an air flow channel inside the fan and is blown into the chamber.

Further, the fan is a cross-flow fan; two ends of the cross-flow fan are provided with shaft discs; the gas outlet end of the dust prevention pipeline is disposed facing the shaft disc; the shaft disc is provided with through-holes (or slots) that communicate inner and outer sides of a hollow room of the cross-flow fan; and the working gas discharged from the dust prevention pipeline enters the hollow room of the cross-flow fan through the through-holes.

Further, the through-holes are spiral and inclined, tending to force a gas outside the shaft disc to flow into the hollow room of the cross-flow fan through the through-holes when a motor drives the shaft disc to rotate.

Preferably, an impeller is connected to a middle shaft body through connecting rib fins; each through-hole or slot is formed between two adjacent connecting rib fins; the connecting rib fins are spiral and inclined likes blades, thereby forcing the gas outside to flow into the hollow room during rotation; and in this way, the working gas inside the dust prevention pipeline is forced to flow out through the negative pressure.

The dust prevention pipeline can be a gas flow channel located inside a component such as a side wall or bottom plate of the discharge chamber, or a pipeline located outside the discharge chamber.

Further, the slit includes a main body and a plurality of turbulence fins; on a projection plane perpendicular to a direction of laser output, the turbulence fins are symmetrically arranged on left and right or upper and lower sides of the main body to form a laser passage (i.e. the slit) for allowing the laser to pass through; and in the direction of laser output, the turbulence fins are staggered on the left and right or upper and lower sides.

Further, in the direction of laser output, a cross-section of the laser passage gradually decreases. In other words, in a direction from the laser output window to an internal space of the chamber, the laser passage takes on a flared shape, with an opening gradually increasing.

Further, the shaft bodies at two ends of the cross-flow fan are rotatably provided on the chamber through bearings; an outer circle of the shaft body adjacent to an outer end surface of the bearing is provided with a threaded structure, a tooth structure or a blade structure; and when the motor drives the shaft body and the impeller to rotate, the threaded structure, the tooth structure or the blade structure forces the gas outside the bearing to move away from the bearing (generally towards an internal space of the cross-flow fan and the internal space of the chamber) to prevent the dust inside the chamber from approaching and entering the bearing.

Further, the chamber is provided with a mounting hole; the threaded structure, the tooth structure or the blade structure on the shaft body is inserted into the mounting hole; and when the cross-flow fan rotates, a dynamic sealing structure is formed between the threaded structure, the tooth structure or the blade structure and the mounting hole.

There is a small gap, for example, a gap not greater than 0.5 mm, between an inner wall of the mounting hole and the threaded structure, the tooth structure or the blade structure. When the cross-flow fan rotates at high speed, the threaded structure, the tooth structure or the blade structure rotates to generate a cyclonic vortex, forcing the gas to flow towards an outside space of the mounting hole and towards the chamber. In this way, the mounting hole and the threaded structure, the tooth structure or the blade structure combine to form a good dynamic sealing structure, preventing dust from entering the bearing.

Further, a plurality of blades are provided on an outer end surface of the shaft disc of the cross-flow fan and along a circumferential direction of the shaft body; and when the motor drives the bearing, the shaft disc and the blades to rotate, the blades tend to force the gas adjacent to the bearing and the shaft body to flow away from the bearing and the shaft body (forming a low-pressure zone adjacent to the bearing and the shaft body).

Further, on the outer end surface of the shaft disc, the through-holes are located between the shaft body and the blades; and the plurality of through-holes are spaced in the circumferential direction of the shaft body.

Further, on the outer end surface of the shaft disc, there is a radially protruding annular baffle between the through-holes and the blades.

The baffle is as close as possible to a side of the chamber to form a relatively enclosed ring space, thereby guiding the working gas discharged from the dust prevention pipeline.

The cross-flow fan adopts a prior art. The cross-flow fan includes the impeller surrounded by a blade grid in a ring shape. The impeller is provided therein with the hollow room. Two ends of the impeller are provided with the shaft discs and the shaft body.

The present disclosure further provides a laser, including the aforementioned dustproof structure for a laser output window.

With the above technical solutions, the present disclosure has the following beneficial effects.

The dustproof structure provided by the present disclosure is a simple structure. The gas outlet end of the dust prevention pipeline is connected to the fan and the gas inlet end of the dust prevention pipeline is connected to the gas purifier. At least a portion of the working gas purified by the gas purifier flows through the dust prevention pipeline to the cavity between the laser output window and the slit. When the cleaned working gas flows through the cavity, the fan guides the working gas so as to increase the flow rate of the gas passing through the cavity, thereby strengthening the blowing of the clean gas on the laser output window and effectively preventing dust particles in the working gas, which comes from the chamber and enters the cavity through the window of the slit, from approaching and contaminating the laser output window.

### BRIEF DESCRIPTION OF THE DRAWINGS

In order to illustrate the specific implementations of the present disclosure or the technical solutions in the prior art more clearly, the drawings that need to be used in the description of the specific implementations or the prior art will be briefly described below. Apparently, the drawings in the following description are some implementations of the present disclosure. For those of ordinary skill in the art, other drawings can also be obtained based on these drawings without creative efforts.

FIG. 1 is a schematic view (top view) of an exhaust channel of a metal fluoride trap (MFT) and a laser output window and a slit of a laser in the prior art;

FIG. 2 is a structural view of a dustproof structure for a laser output window of a laser according to Embodiment 1 of the present disclosure;

FIG. 3 is a stereoscopic section view of a dust prevention pipeline;

FIG. 4 is a structural view of the dust prevention pipeline and a cavity according to Embodiment 1;

FIG. 5 is a partial structural view of a laser output window, the cavity, and a slit according to Embodiment 1;

FIG. 6 is a schematic view of a working gas flowing back to a chamber through a cross-flow fan;

FIG. 7 is a stereoscopic view of the slit according to Embodiment 1;

FIG. 8 is a structural view of staggered turbulence fins of the slit according to Embodiment 1;

FIG. 9 is a structural view of a bearing and a shaft body according to Embodiment 1;

FIG. 10 is a partial perspective view of the shaft body and a shaft disc according to Embodiment 1;

FIG. 11 is an enlarged view of a mounting hole according to Embodiment 1;

FIG. 12 is a schematic view of a design with an independent peripheral fan according to Embodiment 2;

FIG. 13 is a schematic view of a working gas flowing back to a gas purifier according to Embodiment 2; and

FIG. 14 is a schematic view of a laser according to Embodiment 3.

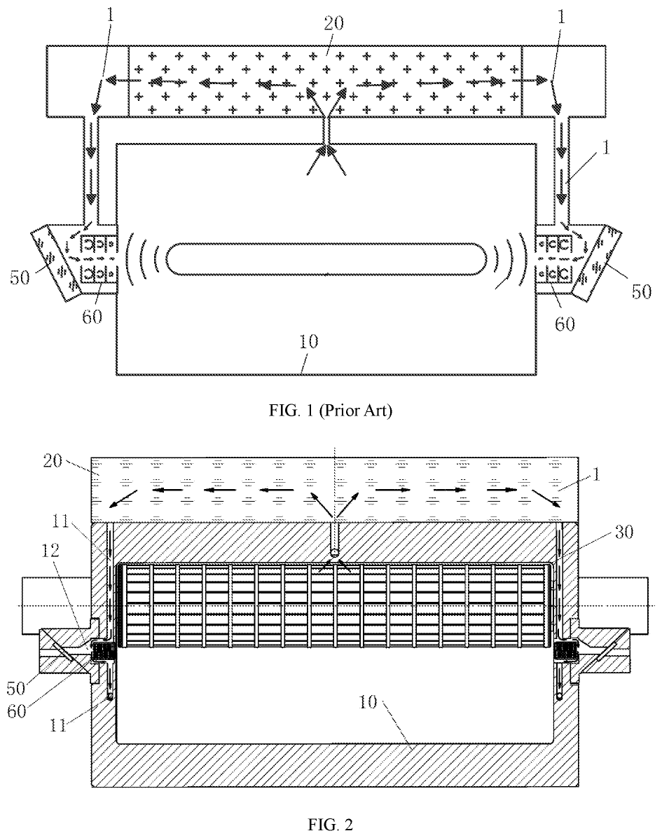

### REFERENCE NUMERALS

1. working gas; 10. chamber; 10a. upper chamber; 10b. lower chamber; 11. dust prevention pipeline; 11a. gas outlet end; 11b. pipe; 12. cavity; 13. bearing; 14. mounting hole; 20. gas purifier; 30. cross-flow fan; 31. impeller; 32. shaft body; 33. shaft disc; 34. threaded structure; 35. blade; 36. through-hole; 37. baffle; 40. motor; 50. laser output window; 60. slit; 61. turbulence fin; 62. laser passage; 63. main body.

### DETAILED DESCRIPTION OF THE EMBODIMENTS

The following clearly and completely describes the technical solutions of the present disclosure with reference to drawings. Apparently, the described embodiments are merely some rather than all of the embodiments of the present disclosure. All other embodiments obtained by those skilled in the art based on the embodiments of the present disclosure without creative efforts shall fall within the protection scope of the present disclosure.

In the description of the present disclosure, it should be noted that orientations or position relationships indicated by terms such as “center”, “top”, “bottom”, “left”, “right”, “vertical”, “horizontal”, “inner”, and “outer” are based on the orientation or position relationships shown in the drawings, for ease of describing the present disclosure and simplifying the description only, rather than indicating or implying that the indicated device or element must have a particular orientation or be constructed and operated in a particular orientation. Therefore, these terms should not be understood as a limitation to the present disclosure. Moreover, the terms “first”, “second”, and “third” are used only for the purpose of description, and are not intended to indicate or imply relative importance.

In the description of the present disclosure, it should be noted that, unless otherwise clearly specified, meanings of terms “mount”, “connected with”, and “connected to” should be understood in a broad sense. For example, the connection may be a fixed connection, a removable connection, or an integral connection; may be a mechanical connection or an electrical connection; may be a direct connection or an indirect connection by using an intermediate medium; or may be intercommunication between two elements. Those of ordinary skill in the art may understand specific meanings of the foregoing terms in the present disclosure based on a specific situation.

The present disclosure is described in further detail below with reference to specific implementations.

### EMBODIMENT 1

As shown in FIGS. 2 to 5, this embodiment provides a dustproof structure for a laser output window of a laser, including discharge chamber 10, gas purifier 20, dust prevention pipeline 11, and cross-flow fan 30. The gas purifier 20 is configured to purify working gas 1 inside the discharge chamber 10. A laser output side of the discharge chamber 10 is provided with laser output window 50 and slit 60. Cavity 12 is provided between the laser output window 50 and the slit 60. The dust prevention pipeline 11 includes a gas inlet end connected to the gas purifier 20, a middle part passing through the cavity 12, and gas outlet end 11a connected to the cross-flow fan 30. At least a portion of the working gas 1 purified by the gas purifier 20 flows through the dust prevention pipeline 11 to the cavity 12 and forms a dustproof gas curtain on an inner side of the laser output window 50, so as to prevent the working gas 1, which comes from the chamber 10 and enters the cavity 12 through a window of the slit 60, from approaching and contaminating the laser output window 50. The cross-flow fan 30 is configured to guide the working gas so as to increase a flow rate of clean gas passing through the cavity 12, thereby strengthening the blowing of the clean gas on the laser output window 50, enhancing the purification of the laser output window 50, and effectively preventing dust particles in the working gas, which comes from the chamber 10 and enters the cavity 12 through the window of the slit 60, from approaching and contaminating the laser output window 50.

As shown in FIG. 2, the chamber 10 includes upper chamber 10a and lower chamber 10p. The cross-flow fan 30 and motor 40 thereof are provided on the lower chamber 10b, and the gas purifier 20 is fixedly provided on the upper chamber 10a.

Preferably, a gas pressure inside the cavity 12 is less than or equal to a pressure inside the discharge chamber 10. During work, the suction of the cross-flow fan 30 or other fan is utilized, and the dust pipeline 11 maintains a set pressure in the cavity 12. The set pressure is less than or equal to the pressure inside the discharge chamber 10. Even if a small amount of particles enter the cavity 12, they will still be carried away by the gas in the dust prevention pipeline 11, thereby avoiding contamination of the laser output window 50. A pressure difference on two sides of the slit 60 is greatly reduced, greatly reducing the impact of a large pressure gradient on beam quality in the prior art.

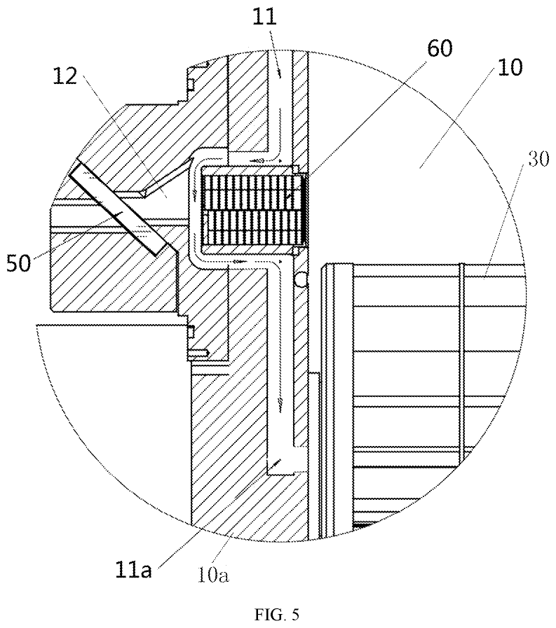

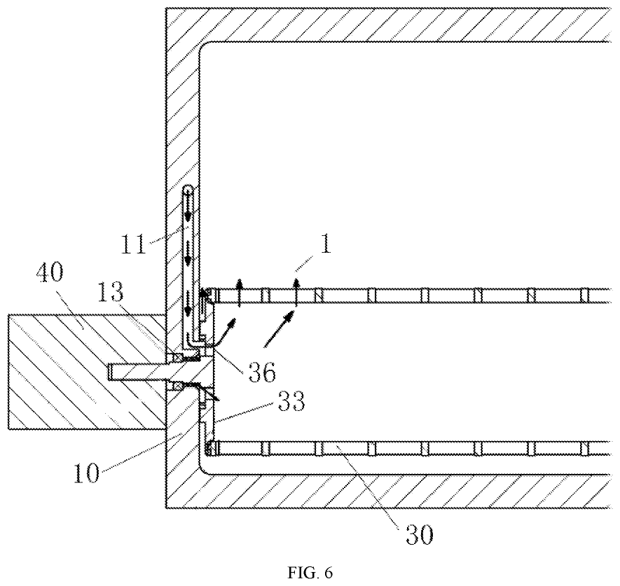

As shown in FIGS. 5 and 6, the working gas 1 in the dust prevention pipeline 11 flows back directly or through a pipeline to the chamber 10 after passing through the fan. The fan rotates and forms a certain negative pressure adjacent to the gas outlet end 11a of the dust prevention pipeline 11, thereby forming a suction force that promotes the flow and outflow of the working gas 1 in the dust prevention pipeline 11. Finally, the working gas enters an air flow channel inside the fan and is blown into the chamber 10.

Specifically, impeller 31 of the cross-flow fan 30 is provided with shaft discs 33 at two ends. The shaft discs 33 are fixedly connected to shaft bodies 32. The gas outlet end 11a of the dust prevention pipeline 11 is disposed facing the shaft disc 33. The shaft disc 33 is provided with through-holes 36 (or slots) that communicate inner and outer sides of a hollow room of the cross-flow fan 30. The working gas 1 discharged from the dust prevention pipeline 11 enters the hollow room of the cross-flow fan 30 through the through-holes 36.

Preferably, the through-holes 36 are spiral and inclined, tending to force a gas outside the shaft disc 33 to flow into the hollow room of the cross-flow fan 30 through the through-holes 36 when the motor 40 drives the shaft disc 33 to rotate.

Preferably, the impeller 31 of the cross-flow fan 30 is connected to the middle shaft body 32 through connecting rib fins. Each through-hole 36 or slot is formed between two adjacent connecting rib fins. The connecting rib fins are spiral and inclined likes blades, thereby forcing the gas outside to flow into the hollow room during rotation. In this way, the working gas 1 inside the dust prevention pipeline 11 is forced to flow out through the negative pressure.

The dust prevention pipeline 11 can be a gas flow channel located inside a component such as a side wall or bottom plate of the discharge chamber, or a pipeline located outside the discharge chamber.

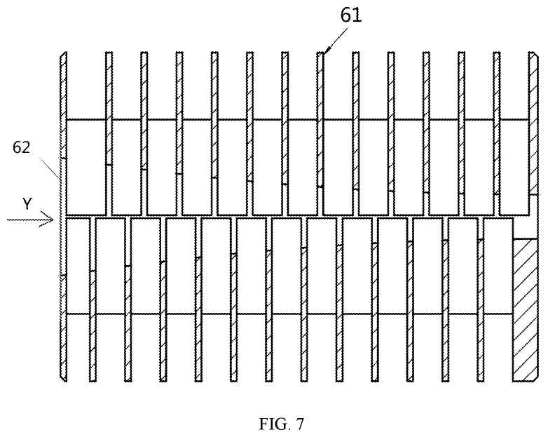

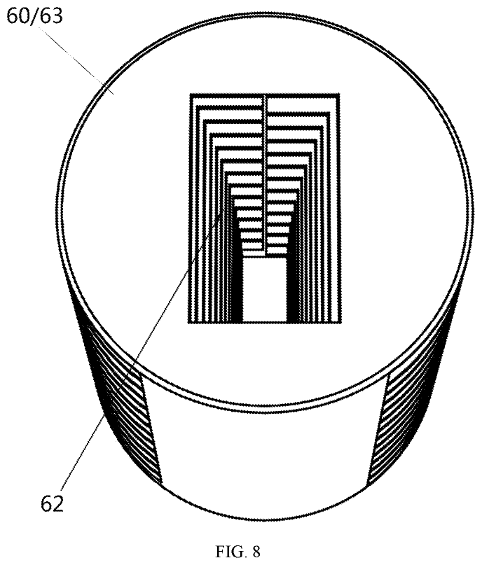

As shown in FIGS. 7 and 8, the slit 60 includes main body 63 and a plurality of turbulence fins 61. On a projection plane perpendicular to a direction of laser output, the turbulence fins 61 are symmetrically arranged on left and right or upper and lower sides of the main body 63 to form laser passage 62 (i.e. the slit 60) for allowing the laser to pass through. In the direction of laser output, the turbulence fins 61 are staggered on the left and right or upper and lower sides. In the direction of laser output, a cross-section of the laser passage 62 gradually decreases. In other words, in a direction from the laser output window 50 to the internal space of the chamber 10, the laser passage 62 takes on a flared shape, with an opening gradually increasing.

The present disclosure improves the structure of the slit by modifying the symmetrical arrangement of the turbulence fins 61 of the slit on the left and right or upper and lower sides into staggered arrangement on the left-right or upper and lower sides. The design effectively reduces spacing between the turbulence fins 61, thereby increasing a resistance of the dust entering the cavity 12 from the chamber 10, effectively reducing the amount of dust entering the cavity 12.

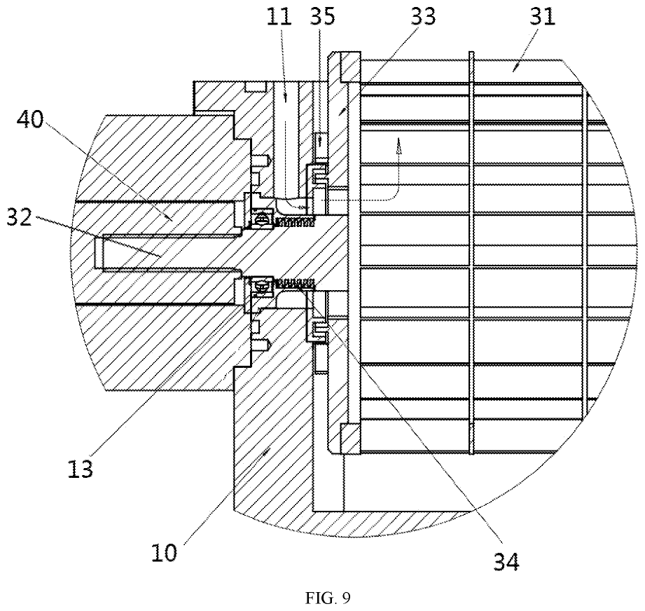

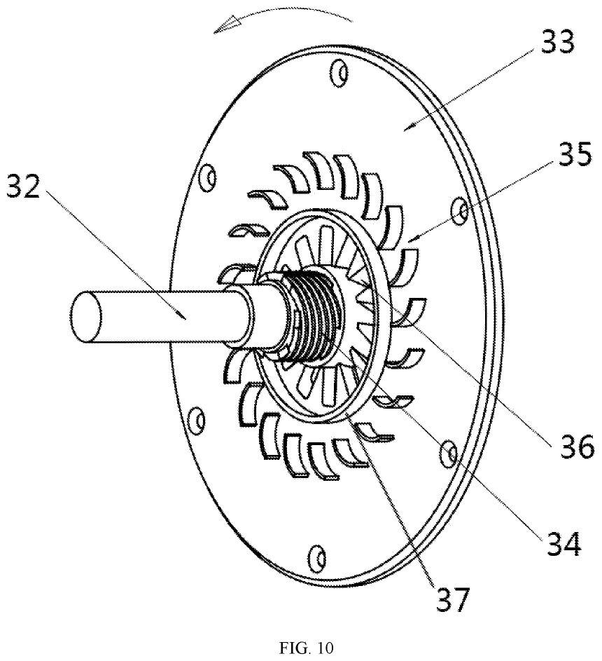

As shown in FIGS. 9 and 10, the shaft body 32 at two ends of the impeller 31 of the cross-flow fan 30 is rotatably provided on the chamber 10 through bearings 13. An outer circle of the shaft body 32 adjacent to an outer end surface of the bearing 13 is provided with threaded structure 34. When the motor 40 drives the shaft body 32, the shaft discs 33, and the cross-flow fan 30 to rotate, the threaded structure 34 forces the gas outside the bearing 13 to move away from the bearing 13 (generally towards an internal space of the cross-flow fan 30 and the internal space of the chamber 10) to prevent the dust inside the chamber 10 from approaching and entering the bearing 13.

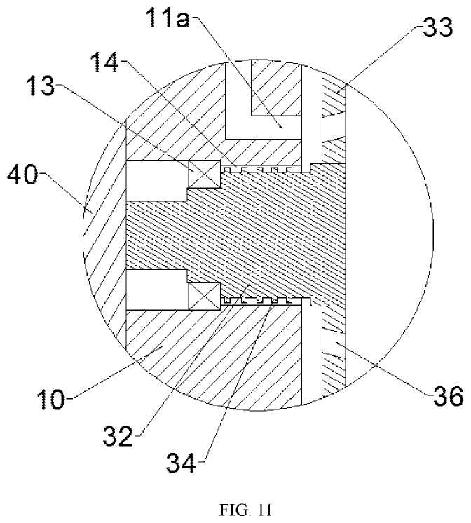

As shown in FIG. 11, a side wall of the chamber 10 is provided with mounting hole 14. The threaded structure 34 on the shaft body 32 is inserted into the mounting hole 14. When the cross-flow fan 30 rotates, a dynamic sealing structure is formed between the threaded structure 34 and the mounting hole 14.

There is a small gap, for example, a gap not greater than 0.5 mm, between an inner wall of the mounting hole 14 and the threaded structure 34. When the cross-flow fan 30 rotates at high speed, the threaded structure 34 rotates to generate a cyclonic vortex, forcing the gas to flow towards an outside space of the mounting hole 14 and towards the chamber 10. In this way, the mounting hole 14 and the threaded structure 34 combine to form a good dynamic sealing structure, preventing dust from entering the bearing 13.

As shown in FIG. 10, a plurality of blades 35 are provided on an outer end surface of the shaft disc 33 of the cross-flow fan 30 and along a circumferential direction of the shaft body 32. When the motor 40 drives the bearing 13, the shaft disc 33 and the blades 35 to rotate, the blades 35 tend to force the gas adjacent to the bearing 13 and the shaft body 32 to flow away from the bearing 13 and the shaft body 32 (forming a low-pressure zone adjacent to the bearing 13 and the shaft body 32).

Further, on the outer end surface of the shaft disc 33, the through-holes 36 are located between the shaft body 32 and the blades 35. The plurality of through-holes 36 are spaced in the circumferential direction of the shaft body 32. On the outer end surface of the shaft disc 33, there is a radially protruding annular baffle 37 between the through-holes 36 and the blades 35. More preferably, a side of the chamber 10 is provided with a ring groove. The baffle 37 is rotatably inserted into the ring groove. A dynamic sealing structure is formed between the baffle 37 and the ring groove.

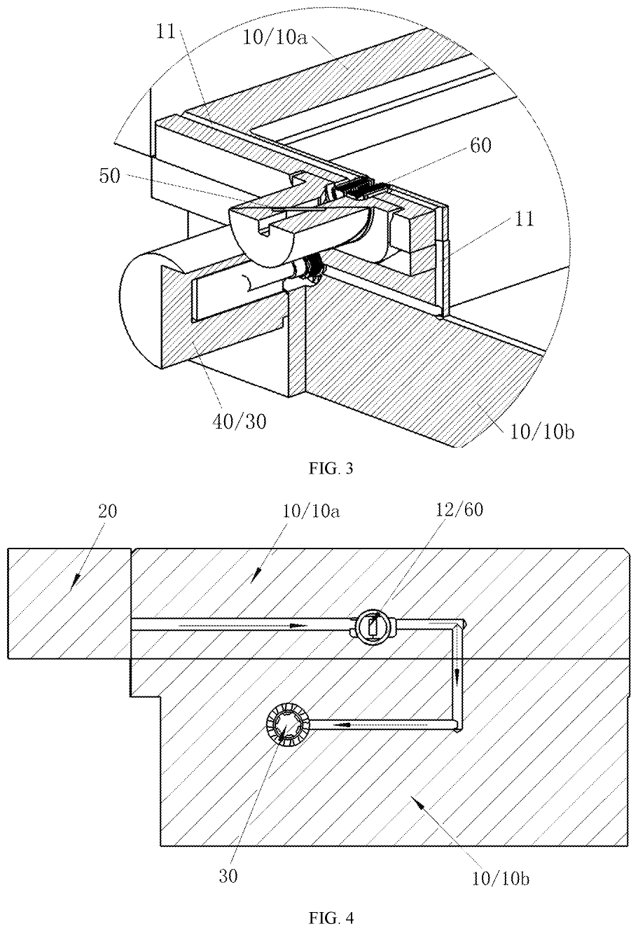

As shown in FIGS. 3 and 4, the cross-flow fan 30 can be provided on the lower chamber 10b. Alternatively, as shown in FIG. 5 (horizontal sectional view), the cross-flow fan 30 can be provided on the upper chamber 10a.

### EMBODIMENT 2

This embodiment is basically the same as Embodiment 1 in terms of structure, except the following features.

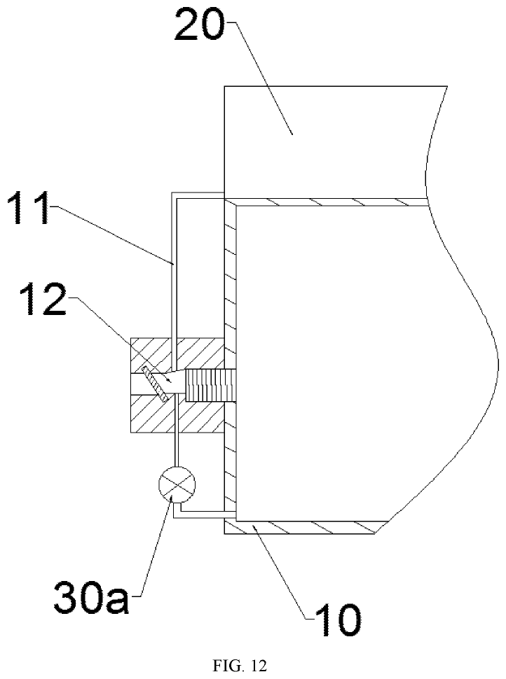

As shown in FIG. 12, the fan is peripheral fan 30a, and the dust prevention pipeline 11 is a conveying pipeline provided outside the chamber 10. The conveying pipeline sequentially connects the cavity 12 and the peripheral fan 30a in series. An air outlet of the peripheral fan 30a is connected to the chamber 10 through a pipe so as to guide the working gas into the chamber 10. The dust prevention pipeline 11 can be a gas branch, which only guides a portion of purified working gas into the cavity 12 for dust prevention of the laser output window 50.

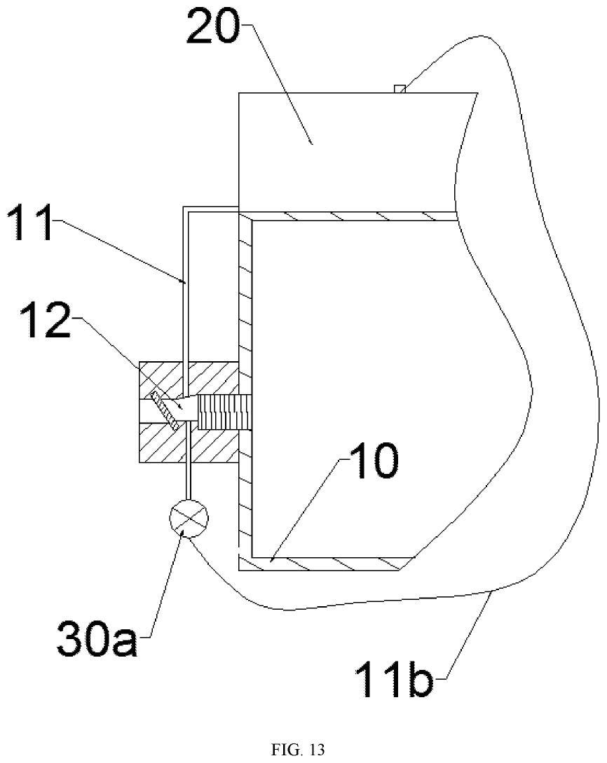

In another implementation of this embodiment, as shown in FIG. 13, the air outlet of the peripheral fan 30a is connected to a gas inlet of the gas purifier 20 through pipe 11b, such that the working gas used for dust prevention in the cavity 12 finally returns to the gas purifier 20.

The dustproof structure provided by the present disclosure is a simple structure. The cavity 12 is located between the laser output window 50 and the slit 60. The cleaned working gas 1 flows through the cavity 12 to form a gas wall or curtain on the inner side of the laser output window 50, effectively preventing particles in the chamber 10 from contaminating the laser output window 50.

The cross-flow fan 30 is configured to guide the working gas so as to increase a flow rate of clean gas passing through the cavity 12, thereby strengthening the blowing of the clean gas on the laser output window 50, enhancing the purification of the laser output window 50, and effectively preventing dust particles in the working gas, which comes from the chamber 10 and enters the cavity 12 through the window of the slit 60, from approaching and contaminating the laser output window 50.

### EMBODIMENT 3

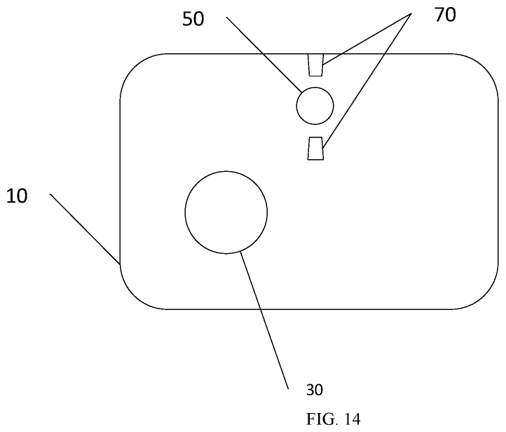

The present disclosure further provides a laser. As shown in FIG. 14, the laser includes discharge chamber 10, cross-flow fan 30, laser output window 50, two opposite discharge electrodes 70, and a dustproof structure (not shown in the figure) described in Embodiment 1 or 2.

In this embodiment, the laser output window 50 of the laser is not easily contaminated and has a long service life.

Finally, it should be noted that the above embodiments are merely intended to describe the technical solutions of the present disclosure, rather than to limit the present disclosure. Although the present disclosure is described in detail with reference to the above embodiments, persons of ordinary skill in the art should understand that they may still make modifications to the technical solutions described in the above embodiments or make equivalent replacements to some or all technical features thereof, without departing from the essence of the technical solutions in the embodiments of the present disclosure.

What is claimed is:

1. A dustproof structure for a laser output window of a laser, comprising a discharge chamber, a gas purifier, a dust prevention pipeline, and a fan, wherein
the gas purifier is configured to purify a working gas inside the discharge chamber;
the discharge chamber is provided with the laser output window and a slit;
a cavity is provided between the laser output window and the slit; and
the dust prevention pipeline comprises a gas inlet end connected to the gas purifier, a middle part passing through the cavity, and a gas outlet end connected to the fan; and at least a portion of the working gas purified by the gas purifier flows through the dust prevention pipeline to the cavity and forms a dustproof gas curtain on an inner side of the laser output window, so as to prevent the working gas that comes from the discharge chamber and enters the cavity through a window of the slit, from approaching and contaminating the laser output window.

2. The dustproof structure for the laser output window of the laser according to claim 1, wherein a gas pressure inside the cavity is less than or equal to a pressure inside the discharge chamber.

3. The dustproof structure for the laser output window of the laser according to claim 1, wherein the working gas in the dust prevention pipeline flows back directly or through a pipeline to the discharge chamber after passing through the fan.

4. The dustproof structure for the laser output window of the laser according to claim 1, wherein the fan is a cross-flow fan; each of two ends of the cross-flow fan is provided with a shaft disc; the gas outlet end of the dust prevention pipeline is disposed facing the shaft disc; the shaft disc is provided with through-holes that communicate inner and outer sides of a hollow room of the cross-flow fan; and the working gas discharged from the dust prevention pipeline enters the hollow room of the cross-flow fan through the through-holes.

5. The dustproof structure for the laser output window of the laser according to claim 4, wherein the through-holes are spiral and inclined, tending to force a gas outside the shaft disc to flow into the hollow room of the cross-flow fan through the through-holes when a motor drives the shaft disc to rotate.

6. The dustproof structure for the laser output window of the laser according to claim 1, wherein the slit comprises a main body and a plurality of turbulence fins; on a projection plane perpendicular to a direction of laser output, the plurality of turbulence fins are symmetrically arranged on left and right or upper and lower sides of the main body to form a laser passage for allowing the laser to pass through; and in the direction of laser output, the plurality of turbulence fins are staggered on the left and right or upper and lower sides.

7. The dustproof structure for the laser output window of the laser according to claim 4, wherein a shaft body at each of the two ends of the cross-flow fan is rotatably provided on the discharge chamber through a bearing; an outer circle of the shaft body adjacent to an outer end surface of the bearing is provided with a threaded structure, a tooth structure or a blade structure; and when a motor drives the shaft body and the cross-flow fan to rotate, the threaded structure, the tooth structure or the blade structure forces the gas outside the bearing to move away from the bearing to prevent dust inside the discharge chamber from approaching and entering the bearing.

8. The dustproof structure for the laser output window of the laser according to claim 7, wherein a side wall of the discharge chamber is provided with a mounting hole; the threaded structure, the tooth structure or the blade structure on the shaft body is inserted into the mounting hole; and when the cross-flow fan rotates, a dynamic sealing structure is formed between the threaded structure, the tooth structure or the blade structure and the mounting hole.

9. The dustproof structure for the laser output window of the laser according to claim 7, wherein a plurality of blades are provided on an outer end surface of the shaft disc of the cross-flow fan and along a circumferential direction of the shaft body; and when the motor drives the bearing, the shaft disc and the plurality of blades to rotate, the plurality of blades tend to force the gas adjacent to the bearing and the shaft body to flow away from the bearing and the shaft body.

10. A laser, comprising the dustproof structure for the laser output window according to claim 1.

11. The laser according to claim 10, wherein a gas pressure inside the cavity is less than or equal to a pressure inside the discharge chamber.

12. The laser according to claim 10, wherein the working gas in the dust prevention pipeline flows back directly or through a pipeline to the discharge chamber after passing through the fan.

13. The laser according to claim 10, wherein the fan is a cross-flow fan; each of two ends of the cross-flow fan is provided with a shaft disc; the gas outlet end of the dust prevention pipeline is disposed facing the shaft disc; the shaft disc is provided with through-holes that communicate inner and outer sides of a hollow room of the cross-flow fan; and the working gas discharged from the dust prevention pipeline enters the hollow room of the cross-flow fan through the through-holes.

14. The laser according to claim 13, wherein the through-holes are spiral and inclined, tending to force a gas outside the shaft disc to flow into the hollow room of the cross-flow fan through the through-holes when a motor drives the shaft disc to rotate.

15. The laser according to claim 10, wherein the slit comprises a main body and a plurality of turbulence fins; on a projection plane perpendicular to a direction of laser output, the plurality of turbulence fins are symmetrically arranged on left and right or upper and lower sides of the main body to form a laser passage for allowing the laser to pass through; and in the direction of laser output, the plurality of turbulence fins are staggered on the left and right or upper and lower sides.

16. The laser according to claim 13, wherein a shaft body at each of the two ends of the cross-flow fan is rotatably provided on the discharge chamber through a bearing; an outer circle of the shaft body adjacent to an outer end surface of the bearing is provided with a threaded structure, a tooth structure or a blade structure; and when a motor drives the shaft body and the cross-flow fan to rotate, the threaded structure, the tooth structure or the blade structure forces the gas outside the bearing to move away from the bearing to prevent dust inside the discharge chamber from approaching and entering the bearing.

17. The laser according to claim 16, wherein a side wall of the discharge chamber is provided with a mounting hole; the threaded structure, the tooth structure or the blade structure on the shaft body is inserted into the mounting hole; and when the cross-flow fan rotates, a dynamic sealing structure is formed between the threaded structure, the tooth structure or the blade structure and the mounting hole.

18. The laser according to claim 16, wherein a plurality of blades are provided on an outer end surface of the shaft disc of the cross-flow fan and along a circumferential direction of the shaft body; and when the motor drives the bearing, the shaft disc and the plurality of blades to rotate, the plurality of blades tend to force the gas adjacent to the bearing and the shaft body to flow away from the bearing and the shaft body.
